(19) United States
(12) Patent Application Publication
(10) Pub. No.: US 2014/0236846 A1
(43) Pub. Date: Aug. 21, 2014

(54) SUBSCRIPTION SERVICE OF APPS IN THE MOBILE MARKET

(71) Applicant: Star Appz Inc., Daly City, CA (US)

(72) Inventors: George Melika, Los Angeles, CA (US); Akbar Thobhani, South San Francisco, CA (US); Anton Sipos, Los Angeles, CA (US)

(73) Assignee: Star Appz Inc., Daly City, CA (US)

(21) Appl. No.: 14/185,743

(22) Filed: Feb. 20, 2014

Related U.S. Application Data
(60) Provisional application No. 61/767,094, filed on Feb. 20, 2013.

(51) Int. Cl. G06Q 50/18; H04W 4/00

(52) U.S. Cl. CPC G06Q 50/184; H04W 4/001
USPC 705/310

(57) ABSTRACT

A subscription service platform and methods for providing an infrastructure to improve monetization of applications in the mobile market are disclosed In one embodiment, a subscription service platform for managing mobile application subscriptions is provided. In one embodiment, a method for managing mobile application subscriptions via download control is provided. The method includes receiving a request to download an application, determining whether a requesting user is licensed to download the application and providing a response allowing or denying the request to download the application based on the determining. In another embodiment, a method for managing mobile application subscriptions via server control is provided. The method includes receiving a request to access an application on a mobile device initiated by the application or an envelope wrapping the application, determining whether a license status associated with a requesting user and the application and providing a response based on the license status.

### CROSS-REFERENCE TO RELATED APPLICATION(S)

This application claims priority to and benefit from U.S. Provisional Application Ser. No. 61/767,094 titled “Subscription Service of Apps in the Mobile Market” filed on Feb. 20, 2013, the entire content of which is expressly incorporated by reference herein.

### FIELD OF INVENTION

The present invention relates generally to a subscription service, and more particularly to a subscription service platform and system and methods for providing a license management infrastructure to improve monetization of applications in the mobile market.

### BACKGROUND

Licensing of software offers an opportunity to monetize on user devices, especially in the mobile market. However, due to the limitations in current infrastructure, it is often difficult to accurately track, verify, and manage licensing subscriptions of applications in the mobile market.

### BRIEF DESCRIPTION OF THE DRAWINGS

One or more embodiments of the present disclosure are illustrated by way of example and not limitation in the figures of the accompanying drawings.

FIG. 1 is a block diagram of a networked-based environment in which some embodiments of the present disclosure may operate.

FIGS. 2(A)-2(C) are block diagrams of licensing infrastructures in accordance with various embodiments of the present disclosure.

FIG. 3 is a block diagram of a recommendation engine in accordance with an embodiment of the present disclosure.

FIG. 4 is a block diagram of a subscription sharing system in accordance with an embodiment of the present disclosure.

FIG. 5 is a block diagram of a license management server implementing a licensing framework in accordance with one or more embodiments of the present disclosure.

FIG. 6 is a block diagram of a mobile device implementing a licensing framework in accordance with one or more embodiments of the present disclosure.

FIG. 7 is a logic flow diagram of an example method of controlling download of an application based on license status verification in accordance with an embodiment of the present disclosure.

FIG. 8 is a logic flow diagram of an example method of controlling access of an application on a mobile device based on license status verification in accordance with one or more embodiments of the present disclosure.

FIG. 9 shows a diagrammatic representation of a machine in the example form of a computer system within which a set of instructions, for causing the machine to perform any one or more of the methods discussed herein, may be executed.

### DETAILED DESCRIPTION

Various embodiments of the present disclosure include a subscription service platform, system and methods for providing a license management infrastructure to improve monetization of applications in the mobile market. In one embodiment, the subscription service platform facilitates tracking, verifying and managing of licenses available via subscription for applications published and developed by various publishers and developers.

In one embodiment, a subscription service platform for managing mobile application subscriptions is provided. In one embodiment, a method and system for managing mobile application subscriptions and licenses via download control is provided. In one embodiment, methods and system for managing mobile application subscriptions and licenses via server control is provided. In one embodiment, an SDK (software development kit) based licensing infrastructure can be implemented by an application to communicate with a license management service implemented on a mobile device or the server to facilitate license status check and manage the status of the application based on the license status. The SDK is provided to application developers to utilize the license management service provided by the subscription service platform. In another embodiment, an envelope or wrapper based licensing infrastructure can be implemented for facilitating license status check and managing the state of the applications based on the license status. In this embodiment, an envelope is wrapped around the mobile application, allowing the license management method to be implemented without the developer having to write any lines of code or change existing code in the application. In one embodiment, a method and system for recommending applications to mobile application subscribers via a recommendation engine is provided. In one embodiment, a method and system for facilitating mobile application subscriptions through sharing of applications, sharing of application usage information and/or sharing of unused application slots or subscription time, gifting of subscription, and the like are provided.

While, for convenience, embodiments of the present disclosure are described with reference to the mobile market, embodiments of the present disclosure are equally applicable to various other applications where subscription and licensing methods are applicable for controlling access to resources.

Various aspects and examples of the present disclosure will now be described with reference made to the accompanying drawings. Wherever practicable, the same reference numbers will be used throughout the drawings to refer to the same or like parts. Note that the following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

### Terminology

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

The phrases “in some embodiments,” “according to various embodiments,” in the embodiments shown,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

The words “herein,” “above,” “below,” and words of similar import, when used in this application, refer to this application as a whole and not to any particular portions of this application. The words “comprise,” “comprising,” and the like are to be construed in an inclusive sense (i.e., to say, in the sense of “including, but not limited to”), as opposed to an exclusive or exhaustive sense. Additionally, the terms “connected,” “coupled,” or any variant thereof means any connection or coupling, either direct or indirect, between two or more elements. Such a coupling or connection between the elements can be physical, logical, or a combination thereof.

Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. Further, if the Detailed Description states a component or feature “may,” “can,” “could,” or “might” have a characteristic or be included, that particular component or feature is not required to have that characteristic or be included.

### General Description

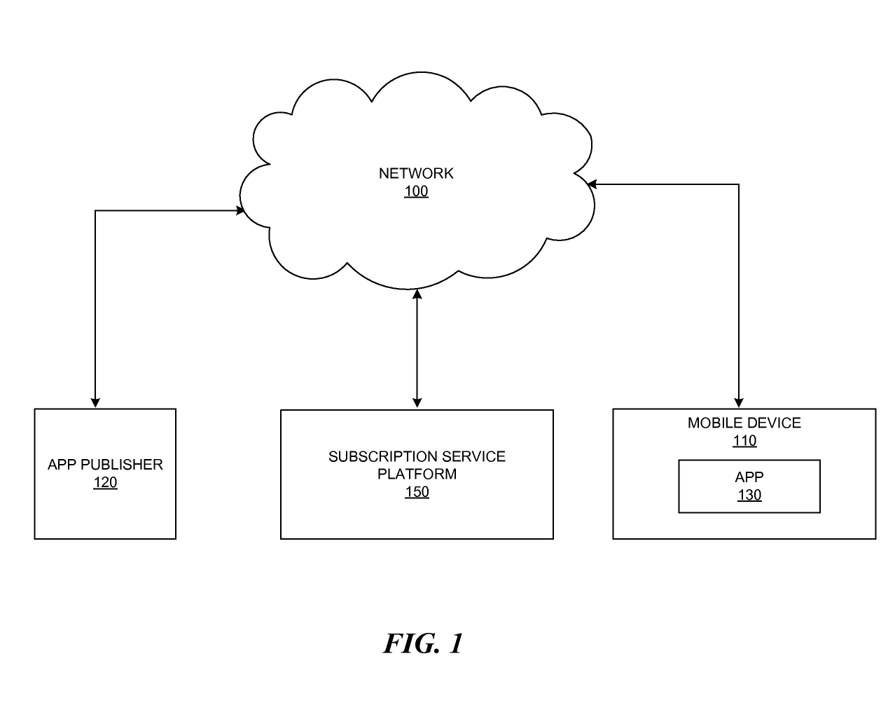

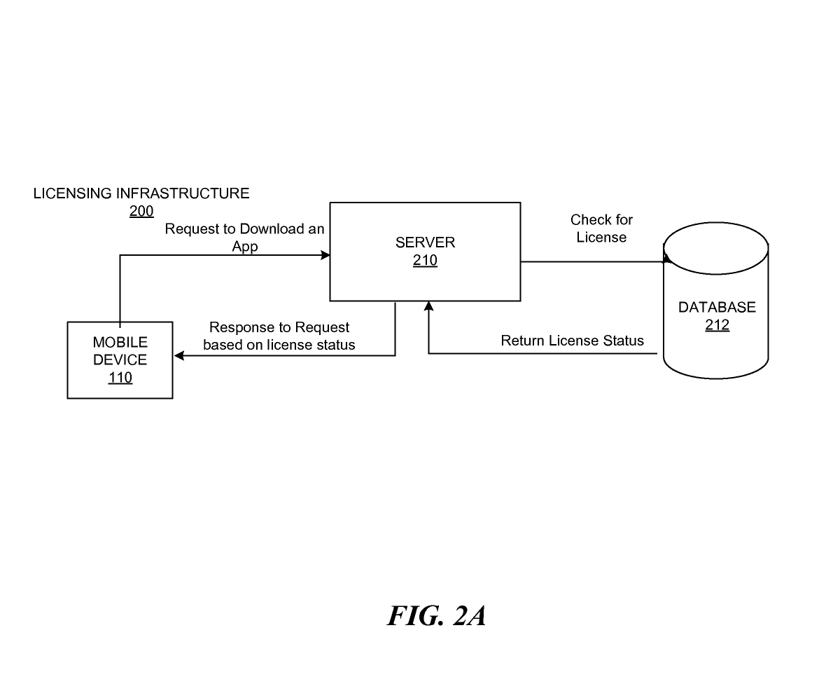

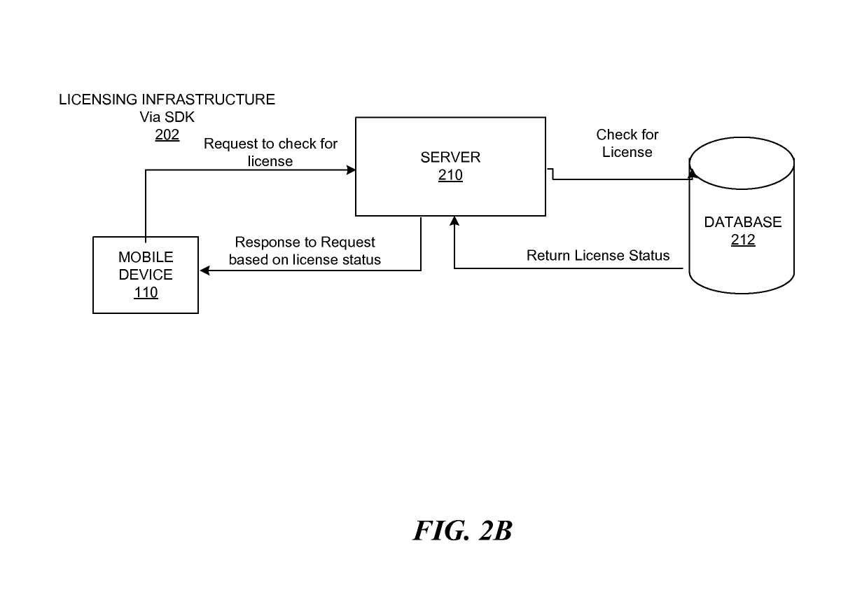

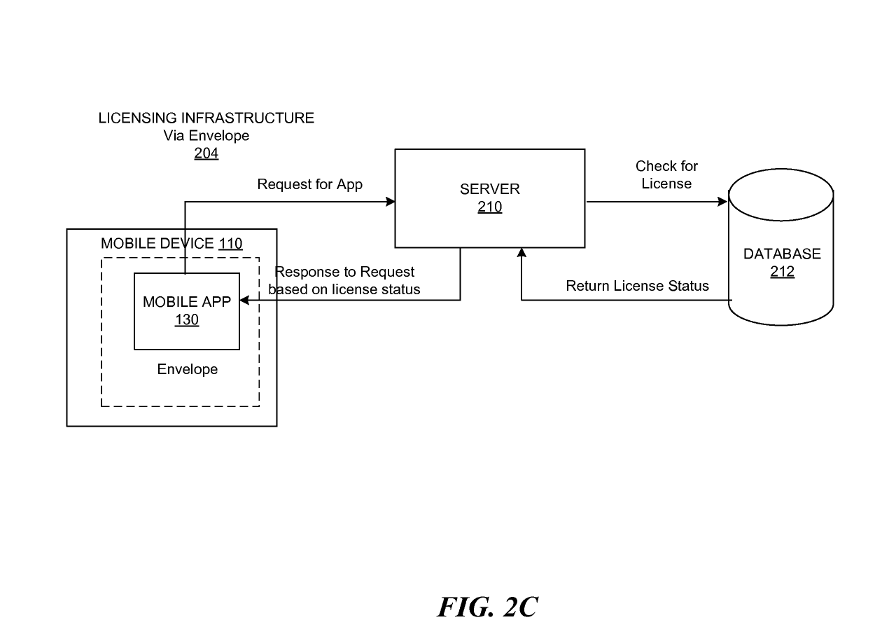

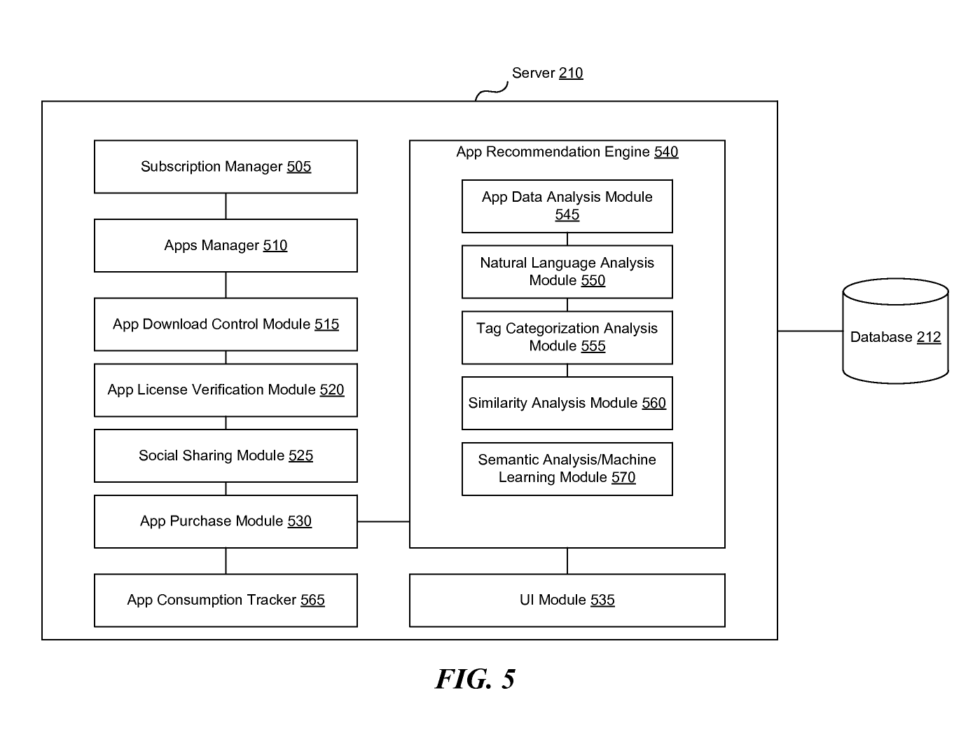

FIG. 1 is a network-based environment 100 in which various embodiments of the present disclosure can be implemented. FIG. 1 includes a mobile device 110, an application publisher 120 (or simply, “app publisher”), an application 130 (or simply, “app”) on the mobile device 110, and a subscription service platform 150, that can communicate with each other via a communications network 100. It is contemplated that the app publisher 120 can be a plurality of publishers and the mobile device 110 can be a plurality of mobile devices requesting access to the plurality of apps. The app 130 can be a plurality of apps provided by the plurality of app publishers 120. In some embodiments, an app publisher 120 can distribute an app 130 via a public app store such as Google Play Store, iOS App Store, PlayPass, a private app store or directly. A user of the mobile device 110 can then access the app publisher's website or an app store to select and download one or more apps 130 to his/her mobile device 110 over the communications network. Typically, app 130 that is installed on the mobile device 110 can communicate with a server associated with the app's publisher over a communications network 100 for app related data. Similarly, app 130 on the mobile device 110 can communicate with the a server (e.g., server 210 in FIGS. 2A-2C and 5) associated with the subscription service platform 130 via the communications network 100 for license verification. The subscription service platform 150, connected to the communications network 100, maintains a licensing infrastructure that manages subscriptions to the app 130 being accessed on the mobile device 110. In various embodiments, the subscription service platform, in full or in part, 150 can reside on the mobile device 110 (e.g., in the app 130, in a subscription service application (e.g., PlayPass app store), in the operating system), on a server (e.g., server 210 in FIGS. 2A-2C and 5) or can be distributed between the mobile device 110 and the server. In some embodiments, the publisher 120 can distribute the app 130 via the subscription service app (e.g., PlayPass). The subscription service app can be a native app (e.g., installed on the mobile device 110 by the device or operating system manufacturer) or an app that is downloaded by a user of the mobile device 110 from an app store or directly from the app publisher. The subscription service app can provide a collection of apps 130 that is available for installation or use on the mobile device 110 under a subscription.

The term “mobile device” or “client device” or “user device” as used herein can include a mobile, hand held or portable devices, wireless devices, or non-portable devices and can be any of, but not limited to, a server desktop, a desktop computer, a computer cluster, or portable devices, including a notebook, a laptop computer, a handheld computer, a palmtop computer, a mobile phone, a cell phone, a smartphone, a PDA, a Blackberry device, a Palm device, any tablet, a phablet (a class of smartphones with larger screen sizes between a typical smartphone and a tablet), a handheld tablet (e.g., an iPad, the Galaxy series, the Nexus, the Kindles, Kindle Fires, any Android-based tablets, Windows-based tablets, or any other tablet), any portable readers/reading devices, a hand held console, a hand held gaming device or console, a head mounted device, a head mounted display, a thin client or any superphone such as the iPhone, and/or any other portable, mobile, hand held devices, or fixed wireless interface such as a M2M device, etc., or any other device having communication capability to connect to the network 100. In one example, the mobile device 110 can connect using one or more cellular transceivers or base station antennas (in cellular implementations), access points, terminal adapters, routers or modems (in IP-based telecommunications implementations), or combinations of the foregoing (in converged network embodiments).

In some instances, the network 100 is the Internet, allowing the mobile device 110 (with, for example, WiFi capability) to access network-based content. The network 100 may be any type of cellular, IP-based or converged telecommunications network, including but not limited to one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), or any broadband network, and further enabled with technologies such as, by way of example, Global System for Mobile Communications (GSM), Personal Communications Service (PCS), Bluetooth, WiFi, Fixed Wireless Data, 2G, 2.5G, 3G (e.g., WCDMA/UMTS based 3G networks), 4G, IMT-Advanced, pre-4G, Long Term Evolution (LTE) Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, HSPA+, UMTS-TDD, 1xRTT, Evolution-Data Optimized (EVDO), messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks, broadband networks, or messaging protocols.

### Subscription Service Platform

In embodiments, various permutations of the subscription service for the apps may be provided to the mobile device 110 through management of the subscription service platform 150. For example, a subscription service can be provided for access to an unlimited number of apps provided by app publishers on the mobile market. In another example, the subscription service can be provided for access to a subset of the apps provided by app publishers on the mobile market. It should be noted that the subscriptions and licenses described in this disclosure are applicable for renting, purchasing and/or sharing applications. In some embodiments, the disclosed platform for providing subscription service can provide one or more subscription plans that customers can choose from and enroll. Each subscription plan can be characterized by features such as price (e.g., per subscription period which can be month, six months, year, etc.), number of apps available for download or number of license activations per subscription period, types or classes of apps available for download or usage, or the like. Table 1 below lists example subscription plans and associated features.

TABLE 1
Example Subscription Service Plans

| | Plan Name | | |
|---|---|---|---|
| | | | All you can |
| | Basic Plan | Premium Plan | eat Plan |
| Monthly Price | $9.99 | $19.99 | $29.99 |
| Number Of App | 10 | 15 | No limit |
| Downloads Per | | | |
| Month | | | |
| Type Of Apps | 8 apps priced | No price limit | No price limit |
| Available For | $2.99 or less + | | |
| Download | 2 apps priced | | |
| | over $2.99 | | |
| Additional | New apps are | New apps are | New apps are |
| Restrictions | available for | immediately | immediately |
| | download 1 week | available for | available for |
| | after release | downloads | downloads |
| After | User can keep | User can keep | Users can keep |
| Subscription | a total of 10 | a total of 20 | a total of 30 |
| Plan Expires | apps, rest | apps and rest | apps and rest |
| | are deleted or | are deleted or | are deleted or |
| | user can pay a | user can pay a | user can pay a |
| | discount price. | discount price. | discount price. |

The subscription plans and associated features provided in Table 1 above are non-limiting examples only and can be modified or customized as needed. For example, the disclosed subscription service platform 150 can offer a family plan. Under a family plan, apps are licensed for downloading to and usage on a maximum number of registered devices (e.g., two devices allowed) and can include other options such as enabling or disabling sync across the devices (e.g., app downloaded to one device is automatically downloaded to the second device or the user of the second device is pinged to download the app), designating one device as the master which can monitor and control download or usage of licensed apps in the other devices registered under the family plan, and the like. In some embodiments, some applications being distributed can have certain characteristics or restrictions which may need to be considered in order to determine whether to allow the applications for download or use. For example, some applications can be available to all users while others may be available to premium users (i.e., users who have signed up for the premium plan) or other select segment of users (e.g., super user with 50 or more downloads per month). By way of another example, some applications may be available for download or use by a limited number of users (e.g., 50 users). By way of yet another example, some applications can be downloaded for a limited time only (e.g., before Feb. 28, 20______).

In one embodiment, a subscription service platform for licensing mobile apps is disclosed. The subscription service platform manages the mobile app subscriptions using a variety of licensing infrastructures.

### Example Licensing Infrastructures

FIG. 2A illustrates an example licensing infrastructure 200 that manages licensing of an app using download control. The license management server 210 of the subscription service platform 150 receives from a customer using a mobile device 110, a download request to download an application. The request can include information that can be used to identify the customer or subscription associated with the request (hereinafter “customer identifying information”. Such customer identifying information can include, but is not limited to: customer identification (ID), device ID, login credentials or access tokens associated with third-party services such as FACEBOOK, TWITTER, GOOGLE, etc., biometric signature, voice signature, or any other information, identification or code that can be used to authenticate a user and grant access to use the app or the subscription service. The server 210 uses the customer or subscription identifying information in the request to verify the license status. In one embodiment, the server 210 queries the database 212 for license status. Based on the license status returned in response to the query, the server 210 provides a response to the request to download the app. The response may be an authorization to download the application or a trigger that causes the download to occur automatically when the license status is valid indicating that the customer's subscription is successfully verified. Alternately, the response may prevent the download from occurring when the license status is invalid indicating that the customer's subscription status cannot be verified (e.g., subscription is expired). In some cases, the customer may be provided alternative options for accessing the application when the license status is invalid. Such alternative options can include but are not limited to: prompting the user to sign up for a subscription, renew the subscription, purchase the app separately, download a version of the app that includes advertisements, has limited features or can be used for a limited period of time or requested to perform a task such as watching or listening to an advertisement or other promotional content, inviting a friend to sign up for the subscription service, sharing app usage related content on social media networks, or the like for a one-time or limited time use of the app.

In another embodiment, the server 210 uses the information in the request (e.g., customer ID and app ID) to verify the customer's subscription to determine whether the customer is licensed to download the app under the subscription. The server 210 can query database 212 for information that is then used to determine whether the customer should be granted license to the requested app. The server 210 then returns a response based on the determination. For example, if the customer's subscription plan allows for download of 50 applications a month, and the customer has already downloaded the maximum allowed for the month, the server 210 can deny the download request and in some cases, provide the customer alternative options for accessing the app such as an option to purchase the requested app separately, upgrade to a subscription plan that allows download of the app, or any other alternative options described in this disclosure. Similarly, if the customer's subscription plan does not meet the requirements to download the requested app (e.g., the price of the app is above the subscription plan limit), the customer can be provided alternative options for accessing the app such as an option to upgrade to another subscription plan, purchase the app separately, download a version of the app that includes advertisements, has limited features or can be used for a limited period of time, or any other alternative options described in this disclosure.

FIGS. 2B and 2C illustrate example licensing infrastructures 202 and 204 respectively for managing licensing using server control.

In one embodiment, an SDK 202 based licensing infrastructure can be implemented to communicate with a license management service implemented on a mobile device or the server 210 to facilitate license status check. The software development kit (SDK) 202 includes a set of tools, libraries (e.g., Application Programming Interface or API libraries), code, documentation, etc., that publishers/developers can use to develop their mobile applications. In one embodiment, the SDK 202 can be a set of APIs that the app can use to make license status checks. Using the SDK 202, publishers/developers can integrate the licensing management methods into their own code to perform license status checks to control access to their mobile apps. Mobile apps can also be developed using the SDK 202 to access the license management service provided by the subscription service platform.

In one embodiment, an application developed using the SDK 202 can be installed on the mobile device 110. When a customer launches the application (or when another trigger is detected), the application checks with the server 210 whether the customer has the license to use the application. The server 210 receives the request from the application on the mobile device 110, queries the database 212 to check for license status associated with the customer and the application and obtain in response to the query a license status. The server 210 then responds to the request based on the license status. In one embodiment, the server 210 can calculate a response to the request based on various parameters such as license status or other information, application restrictions, application characteristics (e.g., free app or shared app), subscription plan features, subscription plan restrictions, parental control rules, and the like. In one embodiment, the server 210 can return additional information such as license validity period, license expiration/refresh date, or other information along with the license status to the app on the mobile device 110. Such additional information can be used by the app to, for example, perform the license status check even when the mobile device is not connected to a network. In one embodiment, the local license status check can be employed to conserve resources of the mobile device and network because the server 210 need not be contacted until the end of the license status expiration date. For example, an app can receive a valid license status along with information that the license status is valid until end of the Jul. 31, 20______ and instructions for managing the app (e.g., disable all features except feature x, y and z, provide a grace period or implement any of the other alternative options described in this disclosure) after the license status becomes invalid. The app can then rely on this information to locally check the license status without having to contact the server 210 until Jul. 31, 20______. After Jul. 31, 20______, if the app is launched while the mobile device 110 is offline, the app can manage itself as instructed until the app can contact the server 210 to refresh the license status of the app (e.g., the app can launch with only features x, y and z enabled or the app can remains operational for a grace period of, for example, 1 day and then disables itself).

In one embodiment, in the event that the subscription gets canceled and the license status is no longer valid and the mobile device 110 is offline, the mobile device can continue to track usage of the apps and report the usage data to the server 210 when network connectivity is available. The server 210 can then take into account the usage of apps after the canceling of the subscription to charge (or refund) the customer. In embodiments, where the mobile device is online, the updated invalid license status can be pushed to the apps on the mobile device to remove or disable the apps. In embodiments, the application may use customer identifying information to initiate the license status check.

In one embodiment, the app developed using the SDK 202 can communicate with a license management service on the mobile device 110 which may then communicate with the server 210 over the network 100 to perform the license status check. In one embodiment, the license management service can be a background service that runs in the background to perform the license status check when triggered by an event. The trigger event can be a launch of the app, use of a certain feature, length of app use, based on a schedule (e.g. check every hour), etc. In other words, the license status check can be performed at any time based on the trigger event. The background service typically runs in a manner that is transparent to the user and does not block user interaction with the mobile device or impact the user experience. In one embodiment, the background service can also be configured to communicate with a local cache or local database storage to obtain previously obtained license status and/or other license status related information to perform a local license status check.

In another embodiment, the license management service can be implemented by the subscription service app on the mobile device. In this embodiment, the app developed using the SDK communicates with the subscription service app on the mobile device for license status information. The subscription service app (e.g., via an API or an associated background service) communicates with the server 210 over the network 100 to obtain a license status and any other related information and provides a response (e.g., valid/invalid license status) to the requesting app. In an embodiment, the subscription service app can retrieve, store and periodically refresh license status information in a local cache or local database storage. The subscription service app can then respond to any license status queries from apps on the mobile device using the locally available license status and other information.

FIG. 2C illustrates envelope 204 based licensing infrastructure for facilitating license status check and managing the state of the apps based on the license status. In this embodiment, an envelope is wrapped around the mobile application, allowing the license management method to be implemented without the developer having to write any lines of code or change existing code in the app. When an envelope “wraps around” the application, the envelope alters the application without involving the original developer and configures the application to communicate with a license management service (on the server 210 or on the mobile device). The envelope can perform all of the functions described in the context of the SDK 202, without the developers having to write additional code or modify existing code in their applications. In one embodiment, an envelope can be added to an application at a binary level, which involves modifying the binary or bytecode of the application. Alternately, the envelope can be added at a higher level to change how the app is launched on the mobile device, without any modification of the application itself. In one embodiment, the server 210 includes a wrapping module that auto wraps applications uploaded by developers with envelopes before distributing the applications wrapped with envelopes to app stores or the subscription service app or providing the applications back to the developers. In one embodiment, the wrapping process can include un-packaging an app, adding the envelope code to wrap the app, and re-packaging the app with the envelope code as a new app containing the licensing mechanism that carries out the license management method.

In one embodiment, the envelope wrapped around an application is launched when a trigger event occurs. The trigger event can be the launch of the application, length of usage of the application, use of a certain feature, and the like. The envelope checks with the license management service which can be implemented on the server 210 or on the mobile device whether the customer has the license to use the app and based on the license status returned by the license management service, manages the state of the app. For example, if the license status is valid, the envelope can allow the app to launch. Conversely, if the license status is invalid, the envelope can disable the app, launch the app with only a few features enabled, launch the app with advertisements, disable the app after a time period, or provide any of the alternative options described in the disclosure. As described with respect to FIG. 2B above, in some embodiments, the license management service (e.g., the server 210) can obtain additional information along with the license status that can be used by the envelope to manage the state of the app, for example, when network connectivity is unavailable or until the license status expires.

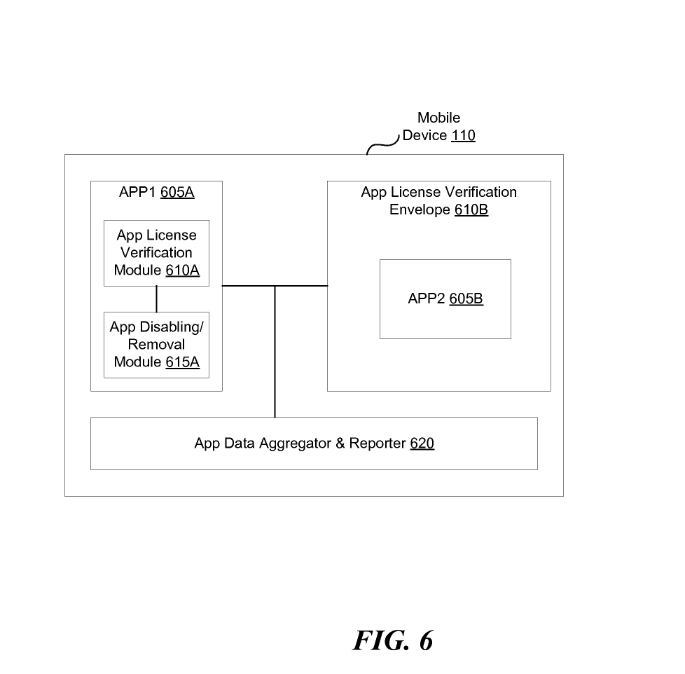

In one embodiment, the envelope and/or SDK can provide other services such as monitoring, aggregating and/or reporting usage data and other analytics as individual events or as aggregate (e.g., via add data aggregator and reporter 620 in FIG. 6). The envelope/SDK can utilize the data collected and/or one or more rules to control usage of applications or control usage of applications by specific users. For example, when a parental control mode is enabled, the envelope/SDK can be configured by a parent to track usage of gaming applications by a child and limit the usage of such applications by the child when a predefined threshold (e.g., 2 hours) is reached. In one embodiment, the usage tracking and control can be across multiple devices that are registered for subscription service. In one embodiment, the envelope/SDK can be used to implement a paywall system that provides controlled access to mobile apps, offers in app purchase options for certain features in an app, or provide access to certain features and functionality of the apps in exchange for customer participation in activities such as watching a video or other promotional content, participating in a survey or feedback, requesting sharing on social networks, etc., that facilitate monetization in the mobile market.

In one embodiment, the envelope/SDK can be implemented to manage access to apps for employees or those who have left employment of a company or organization. For example, a company can subscribe to a company subscription plan that licenses its employees to download and use certain applications on their devices (e.g., personal or company devices). For example, accounting employees can be licensed under the company subscription to download or use apps A-D, while client relations employees can be licensed under the company subscription to download or use apps G-K. The envelope/SDK can use the subscription ID and the employee ID, for example, to perform license checks and control access to the appropriate apps accordingly. When an employee leaves the company, the employee ID can be inactivated or deleted. The license status check would then result in an invalid license status and the ex-employee would be prevented from accessing the apps made available under the company subscription plan. In some instances, the ex-employee may be provided other alternative options to have continued access to the apps.

### Recommendation Engine

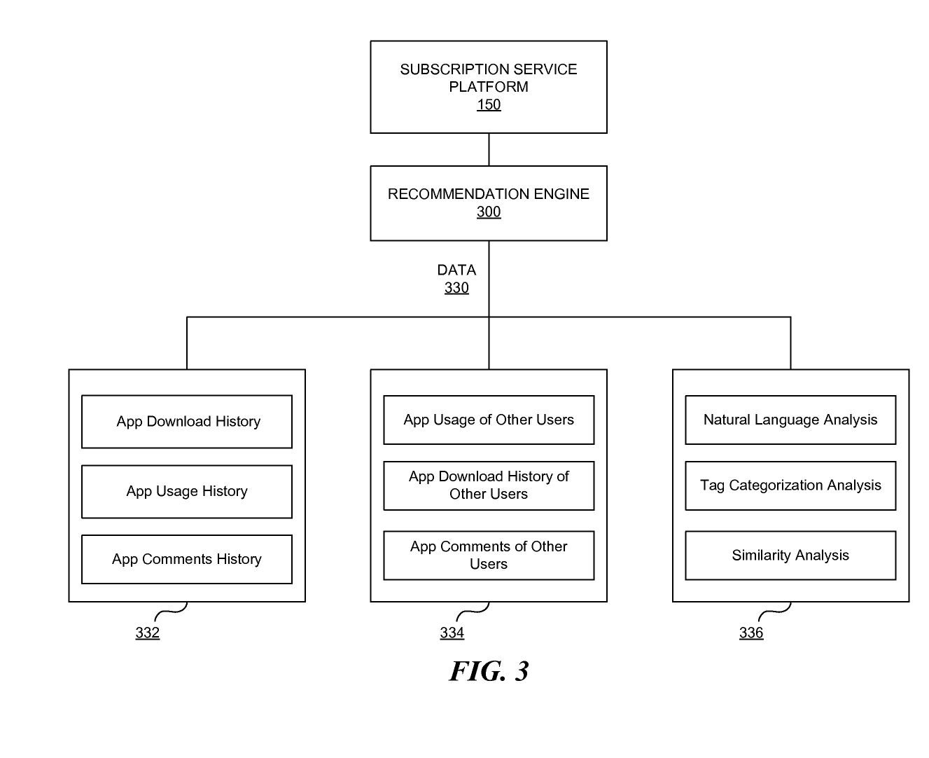

In one embodiment, the subscription service platform 150 can optimize and enhance the subscription service by implementing smart logic to provide users with recommendations about applications. In a market place or app store full of apps to choose from, the recommendation engine 300 of FIG. 3 can enhance discovery of apps that match a user's preference and is thus likely to be used by the user.

The preferences may be determined using historical data 332 associated with the user's likes, comments, download history, usage history (e.g., when and for how long), shares, and the like. The historical data 332 may be collected from the associated apps, the envelope/SDK implementing the license management service, the subscription service app on the mobile device, other third-party services such as social media networks, and the like. The historical data may pertain to apps downloaded via the subscription service platform or any app, regardless of the download source, that is installed or used on the mobile device. The recommendation engine may match users with similar preferences and enable users to recommend apps to other users. The recommendation engine may make recommendations of apps using historical and usage data 324 associated with preferences of other users such as the user's friends.

In one embodiment, the recommendations may be made based on analysis of a user's and/or the other users' app download history, app usage history, app comments, and the like via various analysis techniques 336. For example, a natural language processing analysis can be performed on user comments to determine positive, neutral or negative sentiments, to detect similarity between apps, to identify tags, etc. In some instances, the comments may be those belonging to users on the World Wide Web. In other instances, the comments may be those belonging to users of the apps managed by the platform. In yet other instances, the comments may be those stored in other private databases. Other types of analyses such as semantic analysis or machine learning techniques can also be implemented by the recommendation engine to match users with apps and generate recommendations based on the matching.

In one embodiment, the recommendations may be enhanced based on utilization of “tags.” Each user can “tag” an application and other users are allowed to confirm if they agree with the tag or disagree with the tag. In embodiments, the tags can be crowd-sourced for each app. In one embodiment, the recommendations may be enhanced based on determining similarities between different apps. For example, using tags associated with applications, semantic analysis, machine learning and/or natural language analysis of comments associated with applications, applications can be categorized into buckets or segments of similarity. In some implementations, degree of similarity between apps can also be determined based on tag categorization analysis or other similarity analysis. Based on the similarity category or degree of similarity between the different apps, the recommendation engine may suggest certain apps to users. Further, the suggestions may be based on how often the users certain types of apps. For example, for user A who typically plays App X, a suggestion is made for App Y, which is another gaming app with similar features to App X.

In one embodiment, tags associated with an application can not only be used to classify or categorize the application, but can also provide insights such as how the user thinks and what he or she values. For example, an exercise app can be tagged as a health related app, fitness app, or weight loss app and each would have a different implications of how the user evaluates these apps and what the user prefers. For example, if the user likes an app (e.g., based on high usage or rating) and marks the app as a weight loss app then the user may be interested in other weight loss apps but not necessarily those apps that are tagged as fitness apps.

In one embodiment, the recommendation engine implements a rating system that weighs each user's rating of an app based on several factors such as how often the user uses the app, how often the user rates apps, whether the user is a troll (i.e., a user is a troll if the user's rating falls into a “outlier” category at least a threshold number of times), whether the user shared the app, and the like. The recommendation engine then takes into account the weighted rating in generating recommended apps.

### Sharing Subscription

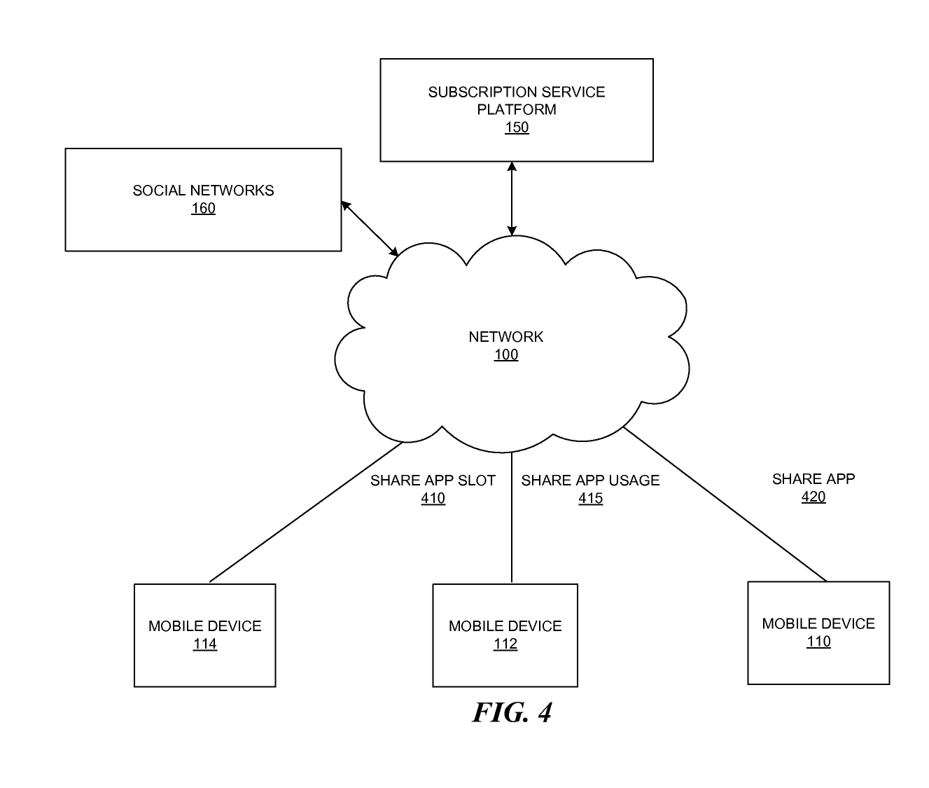

The disclosed subscription service platform 150 can make app purchasing activity social by enabling the ability to share app slots 410, app usage 415 and/or apps between a user of a mobile device 110 and other users such as users of mobile devices 112 and 114, directly, via social networks 160 or via the subscription service platform 150 across network 100 as shown in FIG. 4.

The app usage sharing 415, for example, includes sharing information such as apps currently in use, apps downloaded in the past, apps in the user's wish list, and associated information such as download date, rating, comments, usage, etc. The app usage sharing 415 can also include sharing a photo of an app icon, screen shot, game play, scores or even video, a photo of all apps (or a collection of apps) as one image or video, and the like. The collection can be created in various ways ranging from top used app, user selected, user installed, user commented, rating and other such choices.

In one embodiment, apps can be shared directly between device to device (or person to person) through wired (e.g., USB) or wireless connection (e.g., Bluetooth, WiFi, cellular). The app sharing 420 and the app usage sharing 415 may take place via existing social networks, such as FACEBOOK and TWITTER, or any other private social networks (e.g., companywide social network), collectively referred to as social networks 160 or via the subscription service platform 150.

In some embodiments, the app sharing may be managed based on allocating usage or app slots 410. An original user of an app may choose to share his/her limited number of usage or app slots to other users, such as friends or family members. These other users may be within or outside of the original user's social network. As such, the sharing is inter-social networks. In embodiments, the usage slots may be time-based. For example, a user may have monthly slots available and may choose to share certain months of the subscription service with another user. By way of another example, a user of mobile device 110 may have ten app slots available for a month and the user can share one of his/her app slots with a user of mobile device 112 and another app slot with a user of mobile device 114.

FIG. 5 is a block diagram of the license management server 210 managing subscription using a licensing framework in accordance with one or more embodiments of the present disclosure. In one embodiment, the server 210 includes various components such as a subscription manager 505, an app manager 510, an app download control module 515, an app license verification module 520, a social sharing module 525, an app purchasing module 530, an app consumption/usage tracker 565, an app recommendation engine 540 having an app data analysis module 545, a natural language analysis module 550, a tag categorization analysis module 555, a similarity analysis module 560 and a semantic analysis module 570, and a user interface (UI) module 535.

FIG. 6 is a block diagram of the mobile device 110 that can be in communication with the license management server 210 over network 100. The mobile device 110 can include a plurality of applications such as APP1 605A and APP2 605B. Both APP1 and APP2 can communicate directly with the server 210 or can communicate with a license management service implemented on the mobile device 110 (e.g., background service, subscription service app). In one embodiment, APP1 605A can include an app license verification module 610A and an app disabling/removal module 615A to facilitate verification of license status and management of the application based on license status. In another embodiment, the mobile device 110 can include an app license verification envelope 610B that wraps around the APP2 605B and facilitates verification of license status and management of the application based on license status. Some embodiments of the mobile device 110 can also include an app data aggregator and reporter module 620 that logs or aggregates application usage/consumption data and periodically reports the aggregated usage/consumption data to the server 210. In various embodiments of the server 210 and the mobile device 110, more or less components may be included, some components may be consolidated together, while other components can be omitted. In some embodiments, some of the components of the server 210 may be implemented on the mobile device while some of the components of the mobile device may be implemented on the server 210.

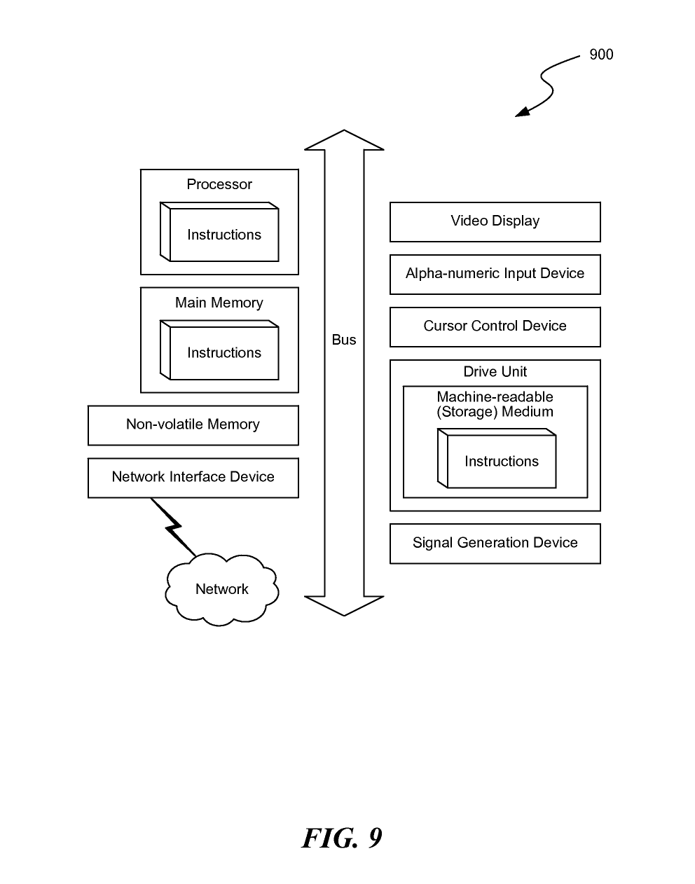

As used herein, a “module,” “a manager,” a “tracker,” an “envelope,” an “aggregator,” a “reporter” or an “engine” includes a general purpose, dedicated or shared processor and, typically, firmware or program modules, which include routines, programs, objects, components, data structures, and so on that perform particular tasks or implement particular abstract data types. The module, manager tracker, envelope, aggregator, reporter or engine including computer-executable instructions such as routines are executed by a processor, a mobile device, a general-purpose computer, a personal computer, a server, or other computing systems such as the machine of FIG. 9. Depending upon implementation-specific or other considerations, the module, manager, tracker, envelope, aggregator, reporter or engine can be centralized or its functionality distributed. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data.

In one embodiment, the subscription manager 505 can manage subscription for users. For example, the subscription manager 505 can, via the user interface module 535, provide a user interface that displays subscription plans available for purchasing and allows a user to select a subscription plan for enrollment. Via the app purchasing module 530, the subscription manager 505 can obtain and process payments for the user-selected subscription plan. The subscription manager 505 can also include a gifting module (not shown) that allows a user to gift subscription service to another user. The user can be charged the gift amount once the recipient of the gift has started the subscription service. The subscription manager 505 can also generate and send notifications to subscribed users regarding subscription renewal, subscription expiration or deletion of downloaded apps after the subscription is expired, and the like. In one embodiment, an indication to delete at least some of the apps licensed under the subscription service can be sent to the mobile device and can be received by a app disabling/removal module (e.g., 615A) which can then act on the instruction from the server 210. The subscription manager 505 can maintain a current subscription status for each user and store data relating to subscription such as customer ID, subscription ID, subscription status, subscription end date, subscription plan ID, billing cycle, billing frequency, list of apps downloaded, device ID, and the like in a customer database table associated with database 212. A subscription plan database table associated with database 212 may also be provided to store information relating to various features of subscription plans (e.g., features listed in Table 1) in association with corresponding subscription plan IDs.

In one embodiment, the app manager 510 can manage apps that are available for download or usage under the subscription service. The app manager 510 can associate each app with a service plan, a price (for purchase a la carte), rating, publisher ID, restrictions, and the like. The app manager 510 can also track and aggregate statistics relating to apps such as the number of times and date/time each app is downloaded, the number of times and date/time each application requests a license status check or license activation, and the like. Information relating to the app such as subscription plan ID, app publisher ID, price, tags, rating, restriction, number of license activations, number of license status checks, number of downloads, and the like may be stored in association with app ID in a database table associated with database 212.

In one embodiment, the app download control module 515 receives from a client device a download request of an application. The app download control module 515 can parse the request to extract customer identifying information and use the extracted information to query the database 212 to verify that the customer's subscription status. The app download control module 515 can then respond to the download request based on the subscription status. In one embodiment, the app download control module 515 can additionally check that the subscription plan associated with the request meets the criteria for downloading the requested app before providing a response allowing or denying the request to download the application. In one embodiment, the app download control module 515 can initiate automatic removal of previously downloaded applications from the client device or can disable the previously downloaded applications in response to the subscription status being invalid. Depending on the implementation, all previously downloaded applications may or may not be subject to automatic removal or disabling. In one embodiment, the application removal or disabling is facilitated by an app disabling/removal module (e.g., 615A) that can be application specific as shown in FIG. 6 or can be a standalone component (e.g., a part of the operating system, or a client/application that is installed on the mobile device separately or a background service). As described before, disabling an application can include a complete disabling of all features of the application or a partial disabling of select features of the application. In one embodiment, the app download control module 515 can offer a purchase option for the application in response to the subscription status being an invalid value.

In one embodiment, the app license verification module 520 receives from an application a verification request associated with a customer using the application and identifies or determines a license status associated with the customer and/or the application. The app license verification module 520 then responds to the verification request based on the license status. In one embodiment, the app license verification module 520 determines whether a valid license to use the application exists for the customer. To make this determination, the app license verification module 520 can check whether the subscription status associated with the customer is valid and that the application is available for usage under the customer's subscription plan. In one embodiment, the app license verification module 520 can provide as provide an invalid or valid license status as response. The license status and/or other license information can be encrypted or obfuscated by the module 520 or an encryption module (not shown) to ensure that the information is secure and cannot be tampered with. In addition to providing license validity status associated with the customer's access right to the application, the app license verification module 520 can also determine and provide other licensing information such as a license validity period associated with duration of the access right or license expiration date. In instances where the license status is invalid, the app license verification module 520 can offer other options such as a license-purchase option, a license-upgrade option, an application-purchase option or an alternative-access option. The alternative-access option may provide the customer access to the application in exchange for participating in a third-party promotional activity or provide the customer access to the application for a limited period of time (e.g., trial period), performing a designated task, or provide the customer access to a feature limited version of the application.

In one embodiment, the verification request from the application is triggered by an application license verification module 610A of APP1 605A. The application license verification module 610A includes customer ID, app ID and/or other identifying information in the verification request and sends the request to the server 210 to allow the server 210 to use the customer ID and/or app ID in determining whether the customer has a valid subscription and has rights to use the application. The app license verification module 610A also receives the response from the server 210 and manages the status of APP1 605A accordingly. For example, if the license status is valid, the app license verification module 610A allows APP1 to return normally. If the license status is invalid, the app license verification module 610A can prompt the customer to purchase a license via subscription, to upgrade the licensing subscription, to purchase the application, or allow the customer access to the application in exchange for participating in a third-party promotional activity, perform a designated task (e.g., send an invite, like in FACEBOOK), provide the customer access to the application for a limited period of time (e.g., trial period), or provide the customer access to a feature limited version of the application.

In another embodiment, the apps manager 510 can include a wrapper module (not shown) that wraps an application with a licensing mechanism such as a licensing envelope described with respect to FIG. 2C prior to making the application available for download or for use. In one embodiment, the mobile device 110 includes an APP2 605B wrapped by an app license verification envelope 610B that acts as a licensing mechanism that is triggered to automatically send the verification request to the server 210 or a license management service on the mobile device in a manner similar to that of the app license verification module 610A. In one embodiment, the app license verification envelope 610B can be dynamically added to the APP2 605B after the application is downloaded to the mobile device 110 (e.g., by an operating system of the mobile device or another client-side component or background service). Alternately, the app license verification envelope 610B can be added by the server 210 by the wrapper module before making the APP2 605B available for download under a subscription plan or before the APP2 is distributed by the publisher via public/private app stores or websites.

In one embodiment, the social sharing module 525 facilitates sharing of application subscription. In one embodiment, the social sharing module 525 receives from a first customer associated with a first client device a subscription share request, verifies a subscription status associated with the first customer; and allocates a subscription access to a second customer associated with a second client device based on the subscription status. In one embodiment, the subscription share request can be a request to share an application slot that is unused by the first customer with the second customer. Using the application slot the second customer can download and use an application that is licensed under the subscription plan of the first customer. In another embodiment, the subscription share request can include a request to share the subscription service with the second customer for a period of time. The social sharing module 525 then determines if the subscription service is paid for the requested period of time and if so, allocates a subscription access to the first customer's subscription service to the second customer for the requested period of time. In yet another embodiment, the social sharing module 525 also allows a customer to share application usage data including an image of all or a subset of applications on the customer's client device via social network channels.

In one embodiment, the app consumption tracker 565 monitors and tracks applications consumed by a customer who has a license subscription. For example, the app consumption tracker 565 can track number of applications downloaded by a customer (e.g., during a subscription period), number of unique license activations where a unique license activation is a first instance of a license verification request for an application made to the server 210, total number of applications making at least one license verification request to the server 210 during a subscription period and the like. In some embodiments, the app consumption tracker 565 can provide app consumption data to the app recommendation engine 540 for use in generating recommendations. The data collected by the app consumption tracker 565 can be used for other purposes such as fraud detection. For example, if a user has downloaded the same app a large number of times or the same app is opened from different locations within a time period, such behavior can indicate fraud. On detecting a fraud event, certain action such as suspending the suspicious customer's subscription or invalidating the license status can be taken to stop and resolve the fraud event. The data tracked by the app consumption tracker can be stored in an app consumption database table in the database 212 in association with a customer ID.

The app recommendation engine 540 can be the recommendation engine 300 described in FIG. 3 and can provide application recommendations to subscribers. In one embodiment, the app recommendation engine 540 determines application preferences of a user associated with a mobile device. In one embodiment, the app data analysis module 545 can analyze application related data (e.g., from the app consumption tracker 565, app data aggregator and reporter module 620, app manager 510) associated with the user to identify the user's preferences and/or create a user profile. The app recommendation engine 540 matches the user with a set of applications corresponding to the application preferences. The app recommendation engine 540 can then generate for the user a plurality of recommendations associated with the set of applications. Alternately, the app recommendation engine 540 can send the plurality of recommendations to the mobile device of the user.

In one embodiment, matching the user with the set of applications corresponding to the application preferences comprises determining a plurality of matching users with similar application preferences as the user (e.g., via the similarity analysis module 560). In one implementation, the plurality of matching users are dynamically ranked based on application usage activities. The app recommendation engine 540 then determines a plurality of applications subscribed by the plurality of matching users and generates the set of applications corresponding to the plurality of applications.

In another embodiment, the app recommendation engine matches the user with the set of applications corresponding to the application preferences by receiving and/or identifying tag data for a plurality of applications (e.g., via the tag categorization analysis module 555), ranking the plurality of applications based on the tag data and generating the set of applications corresponding to the ranked plurality of applications. In one embodiment, the app recommendation engine 540 can utilize the natural language analysis module 550, semantic analysis module 570, machine learning and/or other methods to parse and analyze comments relating to applications found online on social networks, private databases, app stores, and the like to determine general sentiments (positive, negative, neutral) regarding the applications, identify keywords for tagging the applications, and the like. For example, the semantic analysis module 570 can create a user profile from the user's app consumption/usage data, social interaction data, and the like using natural language processing, machine learning and other methods. Similarly, the semantic analysis module 570 can process comments, ratings, reviews, usage patterns and/or other data associated with apps to identify meta data and/or create tags for aps. Various data relating to user preferences, similarity between users, recommended applications for user, and the like can be stored in a recommendation database table in association with a customer ID in the database 212. The app recommendation engine 540 can be executed periodically or on demand to generate recommendations for customers.

In one embodiment, the app data aggregator and reporter 620 of the mobile device 110 can reside inside an application (e.g., inside APP1 605A), as part of the SDK or the envelope 610B or as a separate client-side or server-side component or service. The app data aggregator and reporter 620 can track application usage data by logging each instance of application use, including length of usage, date and time of usage, type of activity, sharing activity, and the like. The app data aggregator and reporter 620 can track the usage data even when the mobile device is offline or not connected to the network. The aggregated usage data is periodically uploaded to the server 210 (e.g., when a network connection is available, after a period of time, or after a certain amount of data is collected).

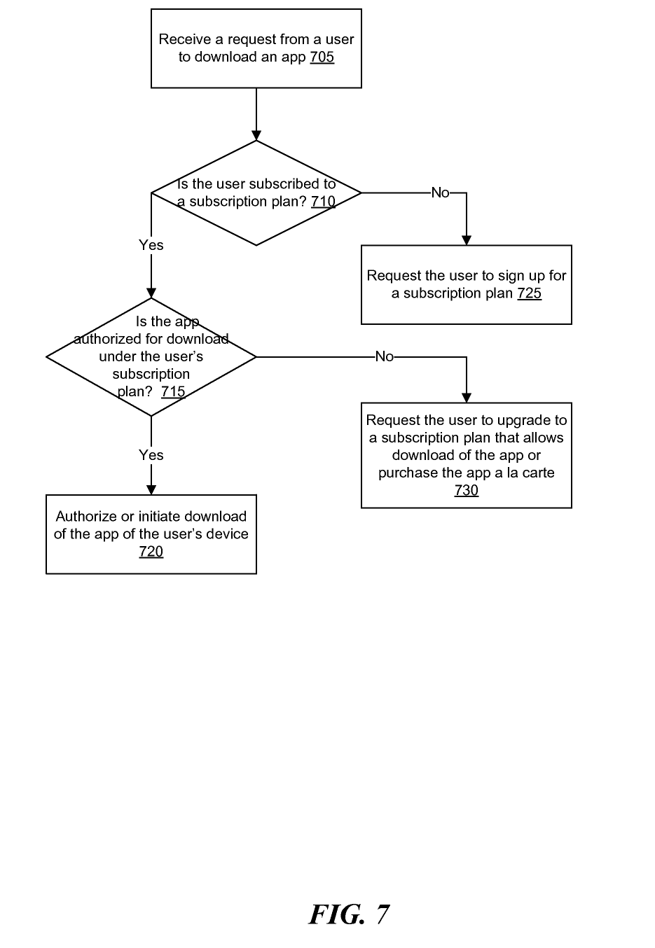

An example method of controlling download of an application based on license verification is depicted in FIG. 7. In this example method, the server 210 receives a request from a user to download an application at block 705. The server 210 can parse the request to determine user ID (or customer ID) and in some instances, app ID. At decision block 710, the server 210 determines if the user is subscribed to a subscription plan by querying a database storing a subscription information relating to the user (e.g., database 212). If the user has a valid subscription (and in some instances even when the subscription is invalid), the server 210 determines if the specific app is authorized for download under the user's subscription plan at decision block 715. If so, the server 210 authorizes the download of the app or automatically initiates download of the app to the user's device at block 720. The user's device can be the same device that is being used to request the app or another designated device or plurality of devices based on the features of the user's subscription plan.

Conversely, if the user is not subscribed to a subscription plan as determined at decision block 710, the server 210 can send a notification to the user at block 725 to request the user to sign up for a subscription plan that allows download of the application. Alternately, the server 210 can request the user to purchase the app a la carte or allow the user access to a version of the app that includes only some of the features of the actual app, allow the user access to the app for a limited duration, or allow the user access to the app in exchange for participating in a promotional activity for a third-party or performing certain tasks such as watching an advertisement or other promotional content, liking the service on FACEBOOK, tweeting, inviting a friend, etc. Similarly, even if the user is subscribed to a subscription plan but the requested app is not authorized for download under that subscription plan as determined at decision block 715, the server 210 can send a notification to the user at block 730 to requesting the user to upgrade to a subscription plan that allows the download of the app or purchase the app a la carte. In some instances, even if the subscription is valid, the server 210 can request the user to upgrade an expiring payment card so that the subscription does not expire, or provide some feedback in the form of rating or tags for apps before allowing the download to occur.

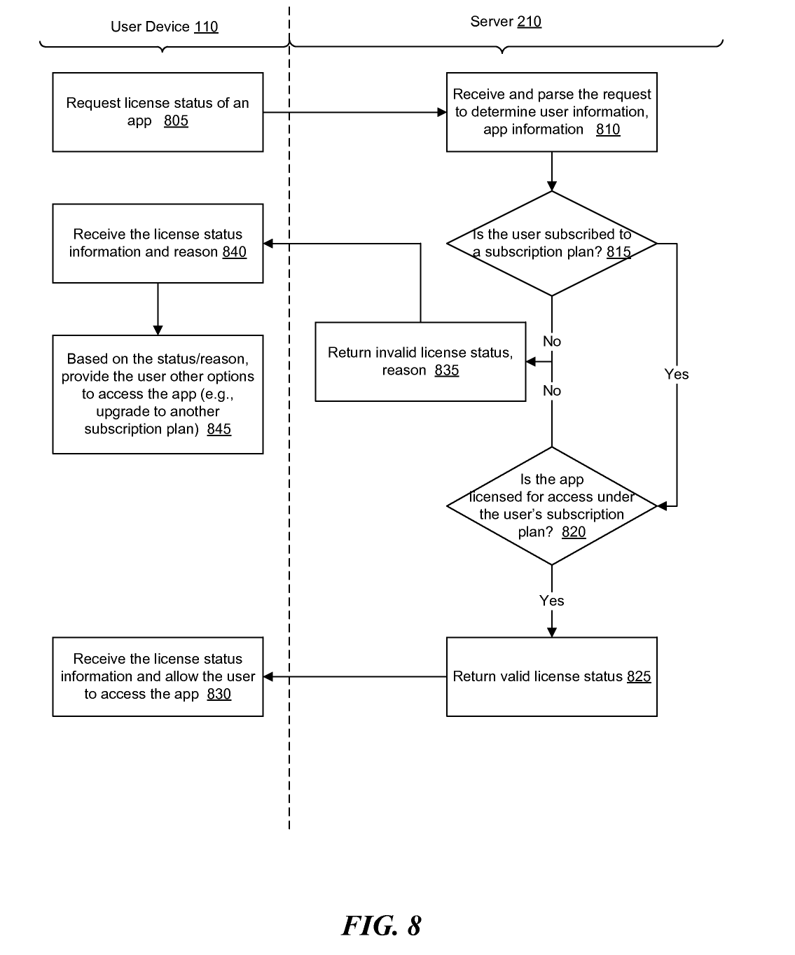

An example method of controlling access to an application on a mobile device based on license verification is depicted in FIG. 8. In this example method, an application on a user device 110 (e.g., the SDK or the envelope wrapping the application) sends a request for a license status of the application at block 805. The server 210 receives and parses the request to extract details of the request such as user identifying information (e.g., user ID) and application information (e.g., app ID). At decision block 815, the server 210 determines whether the user is subscribed to a subscription plan. If so, the server 210 determines if the app is licensed for access under the user's subscription plan at decision block 820. If so, the server 210 returns a valid license status at block 825 to the requesting application (or envelope). The server 210 can also send additional information such as license expiration/refresh date or license validity period to the requesting application on the mobile device 110. The requesting envelope receives the license status information and/or additional information relating to the license at block 830. The license status information can include other security information and can be encrypted or obfuscated to ensure that the license cannot be tampered or altered. The requesting application can then utilize the licensing expiration/refresh date to locally check the license status for the application the next time the application is launched by the user. If the application is launched prior to the licensing expiration date, the license status remains valid, and the user is allowed access to the application. Alternately, if the application is launched after the license expiration date and/or after the grace period, the license status is invalid, and the application would need to contact the server 210 to request license status of the application.

When the user is not subscribed to a subscription plan as determined at decision block 815, or when the user is not subscribed to a subscription plan that meets the requirement for downloading the application as determined at decision block 820, the server 210 can return an invalid license status, and in some instances a reason or a code at block 835. The application can receive the license status information and in some cases the reason code, and based on the status and/or the reason code, provide the user one or more options for accessing the requested app at block 845. As previously described, the options can include purchasing the app, upgrading to another subscription plan, renewing a subscription, accessing a feature-limited or time-limited version of the app or watching advertisements or doing other promotional activity in exchange for accessing the app.

FIG. 9 shows a diagrammatic representation of a machine in the example form of a computer system within which a set of instructions, for causing the machine to perform any one or more of the methodologies discussed herein, may be executed.

In the example of FIG. 9, the computer system 900 includes a processor, memory, non-volatile memory, and an interface device. Various common components (e.g., cache memory) are omitted for illustrative simplicity. The computer system 900 is intended to illustrate a hardware device on which any of the components depicted in the example of FIGS. 1-6 (and any other components described in this specification) can be implemented. The computer system 900 can be of any applicable known or convenient type. The components of the computer system 900 can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as SD Card or equivalents, EPROM, or EEPROM, a magnetic or optical card, or another form of storage for large amounts of data. Some of this data is often written, by a direct memory access process, into memory during execution of software in the computer 900. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, touch screen keypad (including single touch, multi-touch, gesture sensing in 2D or 3D, etc.), a physical keypad, a mouse, a pointer, a track pad, a stylus, a stylus detector/sensor/receptor, motion detector/sensor (e.g., including 1-axis, 2-axis, 3-axis accelerometer, etc.), a face detector/recognizer, a retinal detector/scanner, a light sensor, capacitance sensor, resistance sensor, temperature sensor, proximity sensor, a piezoelectric device, device orientation detector (e.g., electronic compass, tilt sensor, rotation sensor, gyroscope, accelerometer), or any combination of the above and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 9 reside in the interface.

In operation, the computer system 900 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. Other examples of operating systems include but are not limited to, any previous, current, and/or future versions/releases of, Windows Mobile, iOS, Android, Symbian, Palm OS, Brew MP, Java 2 Micro Edition (J2ME), Blackberry, etc.

The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A subscription-based license management method, comprising:
receiving from a mobile device a verification request associated with a user using an application;
determining a license status associated with user,
wherein the license status has a valid value when the user has a valid subscription and the application is licensed for access under the subscription,
wherein the license status has an invalid value when the user has an invalid subscription or when the user has a valid subscription but does not meet the criteria for accessing the application;
responding to the verification request based on the license status.

2. The method of claim 1, further comprising:
prior to receiving the verification request from the mobile device, wrapping an licensing envelope around the application,
wherein the licensing envelope automatically sends the verification request to a license management server whenever a new user is detected using the application.

3. The method of claim 1, wherein the verification request is received from the application on the mobile device or a background service running on the mobile device.

4. The method of claim 1, further comprising:
determining license information including a license validity status associated with access right to the application and a license validity date associated with duration of the access right; and
returning the licensing information along with the corresponding license status to the mobile device.

5. The method of claim 1, wherein responding to the verification request based on the license status comprises at least one of:
offering a licensing-purchase option in response to the license status being an invalid value;
offering a licensing-upgrade option in response to the license status being an invalid value;
offering an application-purchase option in response to the license status being an invalid value;
offering an alternative-access option in response to the license status being an invalid value, the alternative-access option including participating in a third-party promotional activity performing a designated task.

6. The method of claim 1, further comprising:
receiving from the user a subscription share request to share an application with another user;
verifying a subscription status associated with the user; and
allocating a subscription access to the another user based on the subscription status.

7. The method of claim 6, wherein the subscription access to the another user is allocated when the subscription status indicates that the user has a valid subscription and has at least one unused application slot.

8. A mobile device for managing subscription-based licensing, comprising:
a memory;
a processor disposed in communication with the memory and configured to execute a plurality of instructions stored in the memory to:
detect a trigger to verify license status associated with an application;
generate and send a verification request including user identifying information to a license management service;
receive a license status associated with the application from the license management service; and
manage status of the application based on the license status associated with the application.

9. The mobile device of claim 8, wherein the verification request is generated and sent by the application developed using a license verification software development kit.

10. The mobile device of claim 8, wherein the verification request is generated and sent by an envelope wrapping the application.

11. The mobile device of claim 8, wherein the license management service is implemented by a license management server or a background service running on the mobile device.

12. The mobile device of claim 8, wherein the trigger to verify the licensing status includes launching of the application, length of use of the application or activation of a feature of the application.

13. A subscription-based license verification system, comprising:
means for receiving from a mobile device a verification request associated with a customer using an application;
means for identifying a license status associated with the customer or the mobile device; and
means for responding to the verification request based on the license status.

14. The system of claim 13, further comprising:
prior to receiving the verification request, means for enveloping the application with a licensing mechanism,
wherein the licensing mechanism triggers the application to automatically send the verification request to the license management server whenever a new customer is detected using the application.

15. The system of claim 13, wherein the means for identifying a license status associated with the customer or the mobile device comprises:
means for determining whether a license exists for the customer;
means for determining license information associated with the customer's license, the license information including a license validity status associated with an access right to the application and a license validity date associated with duration of the access right; and
means for returning a corresponding license status in encrypted form based on the license information, wherein the corresponding license status is at least one of a valid value or an invalid value.

16. The system of claim 13, wherein the means for responding to the verification request based on the license status comprises at least one of:
means for offering a license-purchase option in response to the license status being an invalid value;
means for offering a license-upgrade option in response to the license status being an invalid value;
means for offering an application-purchase option in response to the license status being an invalid value;
means for offering an alternative-access option in response to the license status being an invalid value, the alternative-access option including participating in a third-party promotional activity or performing a designated task.

17. The system of claim 13, further comprising:
means for determining application preferences of the customer associated with the mobile device;
means for matching the customer with a set of applications corresponding to the application preferences; and
means for sending a plurality of recommendations associated with the set of applications to the mobile device of the customer.

18. The system of claim 17, wherein the means for matching the customer with the set of applications corresponding to the application preferences comprises:
means for determining a plurality of matching customers with similar application preferences as the customer, wherein the plurality of matching customers are dynamically ranked based on application usage activities;
means for determining a plurality of applications subscribed by the plurality of matching customers; and
means for generating the set of applications corresponding to the plurality of applications.

19. The system of 17, wherein the means for matching the customer with the set of applications corresponding to the application preferences comprises:
means for receiving tag data for a plurality of applications;
means for ranking the plurality of applications based on the tag data; and
means for generating the set of applications corresponding to the ranked plurality of applications.

20. The system of claim 13, further comprising:
means for receiving from the customer associated with the mobile device a subscription share request of an application;
means for verifying a subscription status associated with the customer; and
means for allocating a subscription access to another customer associated with another client device based on the subscription status.
